(19) United States
(12) Patent Application Publication
(10) Pub. No.: US 2003/0156136 A1
(43) Pub. Date: Aug. 21, 2003

(54) Method and system for visualization of results of feature extraction from molecular array data

(76) Inventors: Herbert F. Cattell, Mountain View, CA (US); Nicholas M. Sampas, San Jose, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/076,964

(22) Filed: Feb. 15, 2002

(51) Int. Cl. G09G 5/00

(52) U.S. Cl. 345/771

(57) ABSTRACT

A method and system for visual display of feature extraction results to a user of a molecular array feature extraction software package. The feature extraction results are displayed as visual marks superimposed on an image of a molecular array, and numerical and textual feature extraction results for, and other information about, a particular feature may be displayed to a user when the user positions a mouse cursor over the feature in the displayed image. A user may direct display of visual mark for only statistically invalid features and feature backgrounds.

### TECHNICAL FIELD

The present invention relates to the analysis of molecular arrays, or biochips, and, in particular, to a method and system for allowing a user to visualize a scanned image of a molecular array and to visualize the results of feature extraction processing of the scanned image of a molecular array.

### BACKGROUND OF THE INVENTION

Molecular arrays are widely used and increasingly important tools for rapid hybridization analysis of sample solutions against hundreds or thousands of precisely ordered and positioned features containing different types of molecules within the molecular arrays. Molecular arrays are normally prepared by synthesizing or attaching a large number of molecular species to a chemically prepared substrate such as silicone, glass, or plastic. Each feature, or element, within the molecular array is defined to be a small, regularly-shaped region on the surface of the substrate. The features are arranged in a regular pattern. Each feature within the molecular array may contain a different molecular species, and the molecular species within a given feature may differ from the molecular species within the remaining features of the molecular array. In one type of hybridization experiment, a sample solution containing radioactively, fluorescently, or chemoluminescently labeled molecules is applied to the surface of the molecular array. Certain of the labeled molecules in the sample solution may specifically bind to, or hybridize with, one or more of the different molecular species bound to features of the molecular array. Following hybridization, the sample solution is removed by washing the surface of the molecular array with a buffer solution, and the molecular array is then analyzed by radiometric or optical methods to determine to which specific features of the molecular array the labeled molecules are bound. Thus, in a single experiment, a solution of labeled molecules can be screened for binding to hundreds or thousands of different molecular species that together comprise the molecular array.

When one item is indicated as being “remote” from another, this is referenced that the two items are at least in different buildings, and may be at least one mile, ten miles, or at least one hundred miles apart. “Communicating” information references transmitting data representing that information as signals (such as electrical or optical) over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

Molecular arrays commonly contain oligonucleotides or complementary deoxyribonucleic acid (“cDNA”) molecules to which labeled deoxyribonucleic acid (“DNA”) and ribonucleic acid (“RNA”) molecules bind via sequence-specific hybridization. DNA and RNA are linear polymers, each synthesized from four different types of subunit molecules. The subunit molecules for DNA include: (1) deoxy-adenosine, abbreviated “A,” a purine nucleoside; (2) deoxy-thymidine, abbreviated “T,” a pyrimidine nucleoside; (3) deoxy-cytosine, abbreviated “C,” a pyrimidine nucleoside; and (4) deoxy-guanosine, abbreviated “G,” a purine nucleoside. The subunit molecules for RNA include: (1) adenosine, abbreviated “A,” a purine nucleoside; (2) uracil, abbreviated “U,” a pyrimidine nucleoside; (3) cytosine, abbreviated “C,” a pyrimidine nucleoside; and (4) guanosine, abbreviated “G,” a purine nucleoside. When phosphorylated, subunits of DNA and RNA molecules are called “nucleotides” and are linked together through phosphodiester bonds to form DNA and RNA polymers. A DNA nucleotide comprises a purine or pyrimidine base, a deoxy-ribose sugar, and a phosphate group that links one nucleotide to another nucleotide in the DNA polymer. In RNA polymers, the nucleotides contain ribose sugars rather than deoxy-ribose sugars. RNA polymers contain uridine nucleosides rather than the deoxy-thymidine nucleosides contained in DNA. The pyrimidine base uracil lacks a methyl group (130 in FIG. 1) contained in the pyrimidine base thymine of deoxy-thymidine.

In naturally occurring DNA and RNA polymers, the nucleotides are directionally oriented within the polymer, with a phosphate bridge linking the 3′ hydroxyl of each nucleotide to the 5′ hydroxyl of the next nucleotide. DNA and RNA polymers thus generally have a 5′ end and a 3′ end.

The DNA polymers that contain the organization information for living organisms occur in the nuclei of cells in pairs, forming double-stranded DNA helixes. One polymer of the pair is laid out in a 5′ to 3′ direction, and the other polymer of the pair is laid out in a 3′ to 5′ direction. The two DNA polymers in a double-stranded DNA helix are therefore described as being anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. Because of a number of chemical and topographic constraints, double-stranded DNA helices are most stable when deoxy-adenylate subunits of one strand hydrogen bond to deoxy-thymidylate subunits of the other strand, and deoxyguanylate subunits of one strand hydrogen bond to corresponding deoxy-cytidilate subunits of the other strand. AT and GC base pairs are known as Watson-Crick (“WC”) base pairs.

Two DNA strands linked together by hydrogen bonds forms the familiar helix structure of a double-stranded DNA helix. The deoxyribose and phosphate backbones of the two anti-parallel strands each form a separate helix, and the two helices intertwine to form the familiar double helix, with hydrogen-bonded purine and pyrimidine base pairs perpendicular to the axis of the double helix, each strand contributing one base of each base pair. Deoxy-guanylate subunits of one strand are generally paired with deoxy-cytidilate subunits from the other strand, and deoxy-thymidilate subunits in one strand are generally paired with deoxy-adenylate subunits from the other strand.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to reaunealing of the DNA duplex. Strictly A-T and G-C complementarity between anti-parallel polymers leads to the greatest thermodynamic stability, but partial complementarity including non-WC base pairing may also occur to produce relatively stable associations between partially-complementary polymers. In general, the longer the regions of consecutive WC base pairing between two nucleic acid polymers, the greater the stability of hybridization between the two polymers under renaturing conditions.

The ability to denature and renature double-stranded DNA has led to the development of many extremely powerful and discriminating assay technologies for identifying the presence of DNA and RNA polymers having particular base sequences or containing particular base subsequences within complex mixtures of different nucleic acid polymers, other biopolymers, and inorganic and organic chemical compounds. One such methodology is the array-based hybridization assay. FIG. 1 shows a generalized representation of a molecular array. Disk-shaped features of the molecular array, such as feature 101, are arranged on the surface of the molecular array in rows and columns that together comprise a two-dimensional matrix, or grid. Features in alternative types of molecular arrays may be arranged to cover the surface of the molecular array at higher densities, as, for example, by offsetting the features in adjacent rows to produce a more closely packed arrangement of features. In oligonucleotide-based arrays, each feature of the array contains a large number of identical oligonucleotides covalently bound to the surface of the feature. These bound oligonucleotides are known as probes. In general, chemically distinct probes are bound to the different features of an array, so that each feature corresponds to a particular nucleotide sequence.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features may be of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer of a type of which the features are composed). Such interfeature areas typically will be present where the arrays are formed by processes involving drop deposition of reagents but may not be present when, for example, photolithographic array fabrication processes are used,. It will be appreciated though, that the interfeature areas, when present, could be of various sizes and configurations.

The array features can have widths (that is, diameter, for a round spot) in the range from a minimum of about 10 μm to a maximum of about 1.0 cm. In embodiments where very small spot sizes or feature sizes are desired, material can be deposited according to the invention in small spots whose width is in the range about 1.0 μm to 1.0 mm, usually about 5.0 μm to 500 μm, and more usually about 10 μm to 200 μm. Features which are not round may have areas equivalent to the area ranges of round features 16 resulting from the foregoing diameter ranges.

Each array may cover an area of less than 100 cm², or even less than 50, 10 or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Once an array has been prepared, the array may be exposed to a sample solution of target DNA or RNA molecules labeled with fluorophores, chemoluminescent compounds, or radioactive atoms. Labeled target DNA or RNA hybridizes through base pairing interactions to the complementary probe DNA, synthesized on the surface of the array. Target molecules that do not contain nucleotide sequences complementary to any of the probes bound to array surface do not hybridize to generate stable duplexes and, as a result, tend to remain in solution. The sample solution is then rinsed from the surface of the array, washing away any unbound labeled DNA molecules. Finally, the bound labeled DNA molecules are detected via optical or radiometric scanning.

Optical scanning involves exciting labels of bound labeled DNA molecules with electromagnetic radiation of appropriate frequency and detecting fluorescent emissions from the labels, or detecting light emitted from chemoluminescent labels. When radioisotope labels are employed, radiometric scanning can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal.

Generally, radiometric or optical analysis of the molecular array produces a scanned image consisting of a two-dimensional matrix, or grid, of pixels, each pixel having one or more intensity values corresponding to one or more optical or radio signals. Scanned images are commonly produced electronically by optical or radiometric scanners and the resulting two-dimensional matrix of pixels is stored in computer memory or on a non-volatile storage device. Alternatively, analog methods of analysis, such as photography, can be used to produce continuous images of a molecular array that can be then digitized by a scanning device and stored in computer memory or in a computer storage device. In the scanned image of an array, features to which labeled target molecules are hybridized are differentiated from those features to which no labeled DNA molecules are bound. In other words, the digital representation of a scanned array displays positive signals for features to which labeled DNA molecules are hybridized and displays negative features to which no, or an undetectably small number of, labeled DNA molecules are bound. Features displaying positive signals in the digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the array was exposed, of labeled DNA complementary to the oligonucleotide within the feature. The signal intensities are processed by an array-data-processing program that analyzes data scanned from an array to produce experimental or diagnostic results which are stored in a computer-readable medium, transferred to an intercommunicating entity via electronic signals, printed in a human-readable format, or otherwise made available for further use.

Array-based hybridization techniques allow extremely complex solutions of DNA molecules to be analyzed in a single experiment. An array may contain from hundreds to tens of thousands of different oligonucleotide probes, allowing for the detection of a subset of complementary sequences from a complex pool of different target DNA or RNA polymers. In order to perform different sets of hybridization analyses, arrays containing different sets of bound oligonucleotides are manufactured by any of a number of complex manufacturing techniques. These techniques may involve synthesizing the oligonucleotides within corresponding features of the array through a series of complex iterative synthetic steps, or may involve depositing synthesize oligonucleotides onto the features of the array through an automated deposition process such as those employed in ink-jet printers.

As pointed out above, array-based assays can involve other types of biopolymers, synthetic polymers, and other types of chemical entities. For example, one might attach protein antibodies to features of the array that would bind to soluble labeled antigens in a sample solution. Many other types of chemical assays may be facilitated by array technologies. For example, polysaccharides, glycoproteins, synthetic copolymers, including block coploymers, biopolymer-like polymers with synthetic or derivitized monomers or monomer linkages, and many other types of chemical or biochemical entities may serve as probe and target molecules for array-based analysis. A fundamental principle upon which arrays are based is that of specific recognition, by probe molecules affixed to the array, of target molecules, whether by sequence-mediated binding affinities, binding affinities based on conformational or topological properties of probe and target molecules, or binding affinities based on spatial distribution of electrical charge on the surfaces of target and probe molecules.

FIG. 2 illustrates the two-dimension grid of pixels in a square area of a scanned image encompassing feature 101 of FIG. 1. In FIG. 2, pixels have intensity values ranging from 0 to 9. Intensity values of all non-zero pixels are shown in FIG. 2 as single digits within the pixel. The non-zero pixels of this scanned image representing feature 101 of FIG. 1 inhabit a roughly disk-shaped region corresponding to the shape of the feature. The pixels in a region surrounding a feature generally have low or 0 intensity values due to an absence of bound signal-producing radioactive, fluorescent, or chemoluminescent label molecules. However, background signals, such as the background signal represented by non-zero pixel 202, may arise from non-specific binding of labeled molecules due to imprecision in preparation of molecular arrays and/or imprecision in the hybridization and washing of molecular arrays, and may also arise from imprecision in optical or radiometric scanning and various other sources of error that may depend on the type of analysis used to produce the scanned image. Additional background signal may be attributed to contaminants in the surface of the molecular array or in the sample solutions to which the molecular array is exposed. In addition, pixels within the disk-shaped image of a feature, such as pixel 204, may have 0 values or may have intensity values outside the range of expected intensity values for a feature. Thus, scanned images of molecular array features may often show noise and variation and may depart significantly from the idealized scanned image shown in FIG. 1.

FIG. 3 illustrates indexing of a scanned image produced from a molecular array. A set of imaginary horizontal and vertical grid lines, such as horizontal grid line 301, are arranged so that the intersections of vertical and horizontal grid lines correspond with the centers of features. The imaginary grid lines establish a two-dimensional index grid for indexing the features. Thus, for example, feature 302 can be specified by the indices (0,0). For alternative arrangements of features, such as the more closely packed arrangements mentioned above, a slightly more complicated indexing system may be used. For example, feature locations in odd-indexed rows having a particular column index may be understood to be physically offset horizontally from feature locations having the same column index in even-indexed rows. Such horizontal offsets occur, for example, in hexagonal, closest-packed arrays of features.

In order to interpret the scanned image resulting from optical or radiometric analysis of a molecular array, the scanned image needs to be processed to: (1) index the positions of features within the scanned image; (2) extract data from the features and determine the magnitudes of background signals; (3) compute, for each signal, background subtracted magnitudes for each feature; (4) normalize signals produced from different types of analysis, as, for example, dye normalization of optical scans conducted at different light wavelengths to normalize different response curves produced by chromophores at different wavelengths; and (5) determine the ratios of background-subtracted and normalized signals for each feature while also determining a statistical measure of the variability of the ratios or confidence intervals related to the distribution of the signal ratios about a mean signal ratio value. These various steps in the processing of scanned images produced as a result of optical or radiometric analysis of molecular arrays together comprise an overall process called feature extraction. A detailed discussion of feature extraction can be found in the U.S. patent application Ser. No. 09/589,046, “Method and System for Extracting Data From Surface Array Deposited Features,” filed on Jun. 6, 2000.

Prior to being read, an array is typically exposed to a sample (for example, a fluorescently labeled polynucleotide or protein containing sample) and the array then read. As mentioned, typically reading of the array may be accomplished by illuminating the array and reading the location and intensity of resulting fluorescence at each feature of the array,. For example, a scanner may be used for this purpose which is similar to the AGILENT MICROARRAY SCANNER manufactured by Agilent Technologies, Palo Alto, Calif. Other suitable apparatus and methods are described in U.S. patent applications: Ser. No. 09/846125 “Reading Multi-Featured Arrays” by Dorsel et al.; and Ser. No. 09/430214 “Interrogating Multi-Featured Arrays” by Dorsel et al. However, arrays may be read by other methods or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,251,685, U.S. Pat. No. 6,221,583 and elsewhere). The methods of the present invention can be used to obtain results which are further processed using the visually displayed results of the feature extraction process as described herein. Such further processed results may include the user rejecting a feature as being an outlier and/or forming conclusions based on the pattern read from the array after viewing the feature extraction results visually displayed by the method of the present invention. Such further conclusions may include an evaluation as whether or not a particular target sequence may have been present in the sample, or whether or not a pattern indicates a particular condition of an organism from which the sample came. Such methods are known in performing gene expression and diagnostics using arrays. The results may be forwarded as data (such as by communication) to a remote location if desired, and received there for further use (such as further processing).

Molecular array feature extraction software packages currently allow users to view the scanned image of a molecular array on a computer monitor, to configure and launch automated feature extraction from the molecular array, and to view resulting molecular array data. Unfortunately, typical molecular array feature extraction software packages do not provide an intuitive, simple user interface that allows a user to visualize the results of the feature extraction process relative to the scanned image of a molecular array. For example, in many laboratory methods, including gel electrophoresis autoradiography, x-ray diffraction, and other traditionally image-based methods, a scientist or technician can visually inspect a developed image and can visually correlate the quality of the data with numerical data collected from the image by automated scanning and data processing techniques. However, in the case of molecular array, it is quite difficult to make data-quality inferences by visual inspection. The features are small and there are a great number of them, a number of different signals may be superimposed within each feature, and the exact shapes and locations of the features may be difficult to discern. Thus, a scientist or technician must currently rely on numerical data obtained from the scanned image via feature extraction, without being able to quickly check the data against a visual image. Designers, manufacturers, and users of molecular array feature extraction software packages have thus recognized a need for a system and method to allow for visual inspection of feature extraction data in relation to the scanned image of a molecular array.

### SUMMARY OF THE INVENTION

One embodiment of the present invention is a molecular array feature extraction software package that provides a visual display of feature extraction results to a user. The feature extraction results are graphically displayed, superimposed over the scanned image of the molecular array form which feature data is extracted. Visual results include indications of each feature's position and the method by which the feature's position is determined. Displayed visual results also include visual indications of whether or not the feature that is considered to be statistically valid and, if not, to which of several outlier categories the feature has been assigned. Similar displayed results are provided for the background region surrounding each feature. Text-based feature extraction results are prepared by the molecular array feature extraction software package, and, to increase a user's ability to visually scan feature extraction results, portions of the information related to a given feature are displayed in a text display window, or tool tip, when the mouse cursor is positioned over the feature. Because a molecular array may contain a great number of features, even the relatively simple, and visually intuitive, display of feature extraction results may be difficult to efficiently review. In order to visually display feature extraction results in a manner more accessible to visual scanning, the molecular array feature extraction software package provides an option to selectively remove visual display of feature extraction results for valid features and valid backgrounds. Viewing the feature extraction results superimposed on the scanned image of the molecular array following selection of this option allows a user to immediately visualize statistically invalid features and feature backgrounds.

### BRIEF DESCRIPTION OF THE DRAWINGS

FIG. 1 shows a generalized representation of a molecular array.

FIG. 2 illustrates a two-dimensional grid of pixels in a square area of a scanned image.

FIG. 3 illustrates indexing of a scanned image produced from a molecular array.

FIG. 4 shows visual display of the scanned image of a molecular array by a molecular array feature extraction software package prior to feature extraction.

FIG. 5 shows the visual display from a molecular array feature extraction software package following user input to increase magnification of the displayed molecular array image.

FIG. 6 shows the visual display of a molecular array feature extraction software package during feature extraction invocation.

FIG. 7 shows display of the “Load Design File” text input window by a molecular array feature extraction software package.

FIG. 8 shows the visual display featuring the “Feature Extraction Configuration” interactive parameter input window.

FIG. 9 shows feature extraction results displayed superimposed over the scanned image of the molecular array.

FIG. 10 shows display of an “Options” menu that allows selection of the color scale for display of a scanned molecular array image.

FIG. 11 shows display of feature extraction results superimposed on the scanned image of a molecular array following selection, by the user, of a logarithmic color scale.

FIG. 12 shows display of the feature extraction results superimposed on the scanned image of the molecular array in a logarithmic color scale at higher magnification.

FIG. 13 shows the visual feature extraction results key displayed by the molecular array feature extraction software package.

FIG. 14 shows user input to the molecular array feature extraction software package to display visual display markings for only those features characterized during feature extraction as outliers or having outlier backgrounds.

FIG. 15 shows display of feature extraction results for only outlier features or features having outlier backgrounds.

FIG. 16 shows a tool tip displaying numerical and textual information regarding a feature.

FIGS. 17 and 18 show display of a smudged area of the molecular array at higher magnification, with a tool tip displayed for a feature within the smudged region in FIG. 18.

### DETAILED DESCRIPTION OF THE INVENTION

One embodiment of the present invention is a molecular array feature extraction software package that provides a visual display of feature extraction results to a user. A molecular array feature extraction software package may provide for automated feature extraction from scanned images of molecular arrays, semi-automated feature extraction, manual feature extraction, or various combinations of automated and manual feature extraction. Fully automated feature extraction includes: (1) determining the approximate positions of the features, for example, by determining the positions of corner features within the scanned image; (2) indexing the features for numerical or coordinate-based access; (3) determination of reliable regions of the scanned image from which to extract signal data; (4) extraction of signal data from the features and local background regions of the scanned image of the molecular array; and (5) calculation of the statistical variance of extracted features and classification of features and feature backgrounds as being valid or as being outliers.

It should be noted that the term “signal” is employed in the following discussion to indicate the data collected from features of a molecular array by a particular type of analysis. For example, if molecules binding to features are labeled with chromophores, and optical scans at red and green wavelengths of light are used to extract data from the molecular array, then the data collected during the optical scan at the green wavelength may be considered to be the green signal and data collected during the optical scan at the red wavelength may be considered to be the red signal. The term “signal” is also used to refer to data extracted from a particular feature using a particular type of analysis. Thus, for example, in a gene expression experiment, the green signal extracted from a particular feature may be compared to the red signal extracted from the feature in order to measure differential expression of a gene at two different points in time.

In one molecular array feature extraction software package, a scanned image of a molecular array is displayed to a user, representing the raw data collected by automated optical scanning of the array at one or more wavelengths or radiometric scanning within one or more energy ranges. The user may then initiate automated feature extraction via a menu selection and one or more displayed dialogue boxes in which the user selects various feature extraction parameters. Information regarding the scanned molecular array is provided to the molecular array feature extraction software package in a design file, such information including the dimensions of the scanned image of the molecular array in pixels, the number of rows and columns of features within the molecular array, the inter-feature spacing, the number and identity of scanned signals, a character-string representation of the target molecule included in each feature, and other such information. The user may choose automatic, semi-automatic, or manual determination of the x and y coordinates, in units of pixels, of the positions of the corner features, providing indications of the x and y coordinates of one or more corner features for semi-automatic and manual corner feature determination. Once the x and y coordinates, in units of pixels, of the positions of the corner features are determined, estimated, or input to a molecular array feature extraction software package, regions of a scanned image corresponding to the corner features can be further analyzed by the molecular array feature extraction software package to refine the estimated positions of the corner features. For example, the molecular array feature extraction software package may calculate, for a given corner feature, a region of interest that includes pixels with intensity values greater than a threshold pixel intensity value and calculate the x and y coordinates for the corner feature based on the centroid of a group of pixels closest to the center of the region of interest. Alternatively, coordinate refinement may be based on an outer region of interest, a maximally sized elliptical area that will fit within the rectangular portion of a scanned image overlying and centered on a particular feature.

Next, using the refined corner feature positions, as determined by the techniques described in the previous subsection, an initial rectilinear feature coordinate grid can be estimated from the positions of the corner features and the known inter-feature spacing of the molecular array. After computing the initial feature coordinate grid, the different signals for each feature may be processed in order to select strong features, with integrated pixel intensities greater than a statistically determined threshold integrated pixel intensity. The initial positions of internal features may be estimated from the initial feature coordinate grid, and then refined by various techniques. The refined positions of strong features may then be used in a linear regression analysis to produce a refined feature coordinate grid. In subsequent signal extraction and signal variance calculations, the refined positions of the strong features, as determined by centroid-based calculations, are used for calculations of the strong features and their respective local background regions, whereas the fitted or estimated positions based on the refined feature coordinate grid are used for weak features and their respective local backgrounds.

Once feature positions are determined, whether from image analysis of strong features or from linear regression analysis for weak features, a set of pixels from each feature is then selected for signal extraction. The selected pixels for a feature initially comprise those pixels having pixel intensity values for each signal and, optionally, for ratios of all pairs of signals, that fall within acceptable ranges within a selected region corresponding to the feature. Selection of a region for initial pixel selection for a feature can be made on the basis of geometry, e.g. selecting pixels within an ellipsoid of a size and orientation expected to include signal-bearing pixels, or may alternatively be accomplished through morphological analysis of features using image processing techniques.

To facilitate biological interpretation and downstream analysis of the data, the statistical significance of feature signals needs to be determined. A problem arises if, for example, the red channel signal and green channel signal of the same feature are both indiscernible from their surrounding local background, but the green channel signal is twice as bright as the red channel signal. The user, in this case, may obtain a false result indicating a two-fold signal increase by the green channel if the ratios are calculated with data that is not significantly different compared to a control background signal. This problem may be addressed by performing statistical significance tests on feature data. A two-tailed student's t-test is performed on the population of pixels comprising the feature with the appropriate population comprising the background signal. The population used for the background signal depends on the method chosen for background subtraction. This significance information may be used, for example, to calculate the log of the ratio of one color channel signal to another color channel signal of the same feature. This significance information may also be used to test for significance of the red and green channel data. If both color channel signals for a feature are found to be insignificantly different from the population describing the feature's background, typically at a significance level <0.01, then the log ratio log(0/0) is set to be log(1) which is defined to be 0. This avoids the erroneous result of a gene expression level artificially high or low based on data that is considered to be essentially the same as some background level.

Once feature extraction is complete, the numerical feature extraction results are output to a file, in which a numerically sorted list of features and feature extraction results are tabulated. Many molecular array feature extraction software packages require a user to scan such result files in order to qualitatively assess feature extraction results. Unfortunately, because of the large number of features, and because of the potentially large number of data reported, scanning feature extraction output files may be an extremely tedious undertaking.

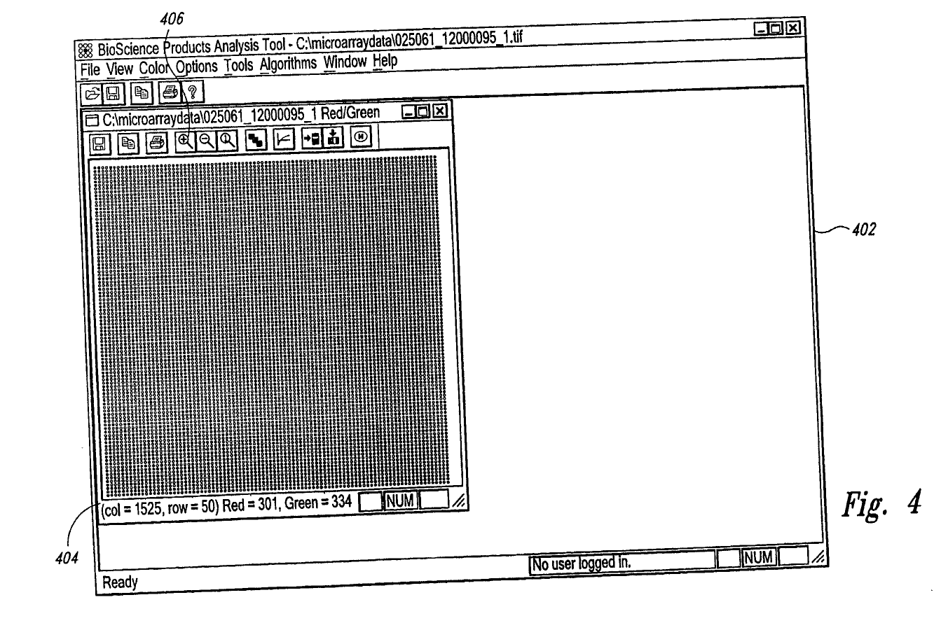

One embodiment of the present invention provides visual display of the feature extraction results, superimposed on a scanned image of the molecular array, in order to facilitate visual qualitative assessment of the feature extraction results by a scientist or technician. These visual display techniques that represent one embodiment of the present invention are described, below, with references to FIGS. 4-18, each of which shows a visual display by the graphical user interface (“GUI”) of a molecular array feature extraction software package that implements one embodiment of the present invention.

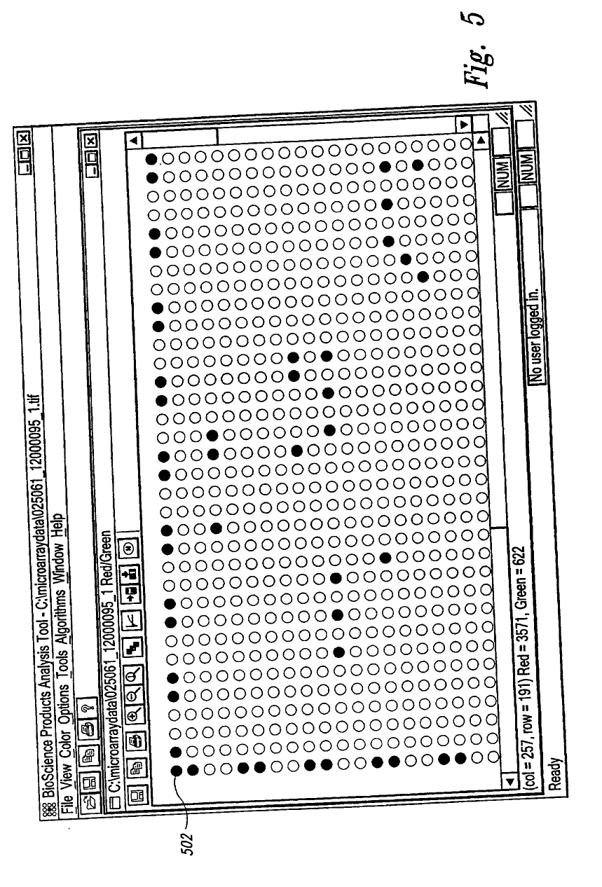

FIG. 4 shows visual display of the scanned image of a molecular array by a molecular array feature extraction software package prior to feature extraction. The visual display comprises a parent window 402 and a molecular array image display window 404. Within the molecular array image display window 404 is a false-color, pixel-based display of a molecular array. A user may input a mouse click to a magnification button 406 in order to view a smaller portion of the scanned image of the molecular array at higher magnification. FIG. 5 shows the visual display from a molecular array feature extraction software package following user input to increase magnification of the displayed molecular array image. At higher magnification, individual features, such as left-hand corner feature 502, are readily and distinctly observed.

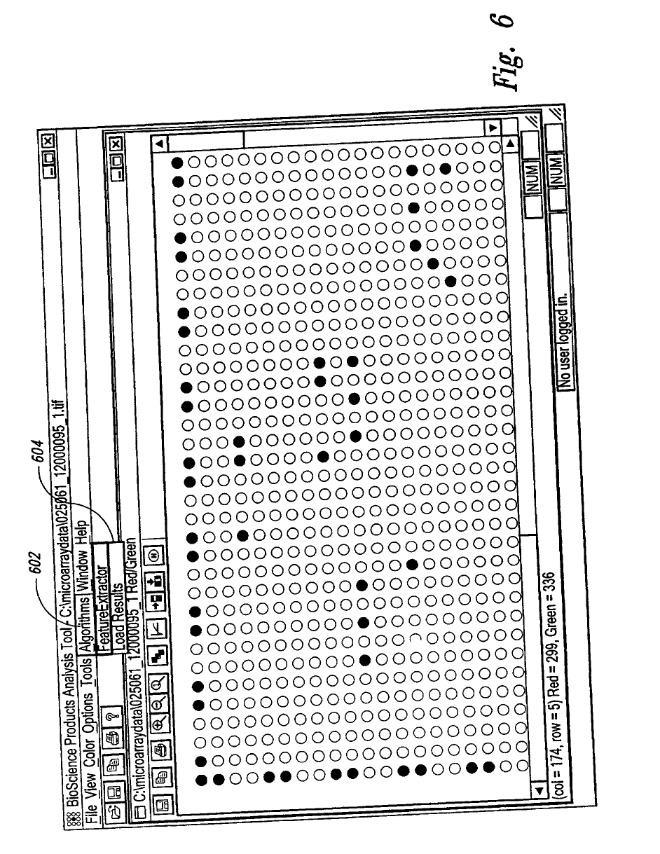

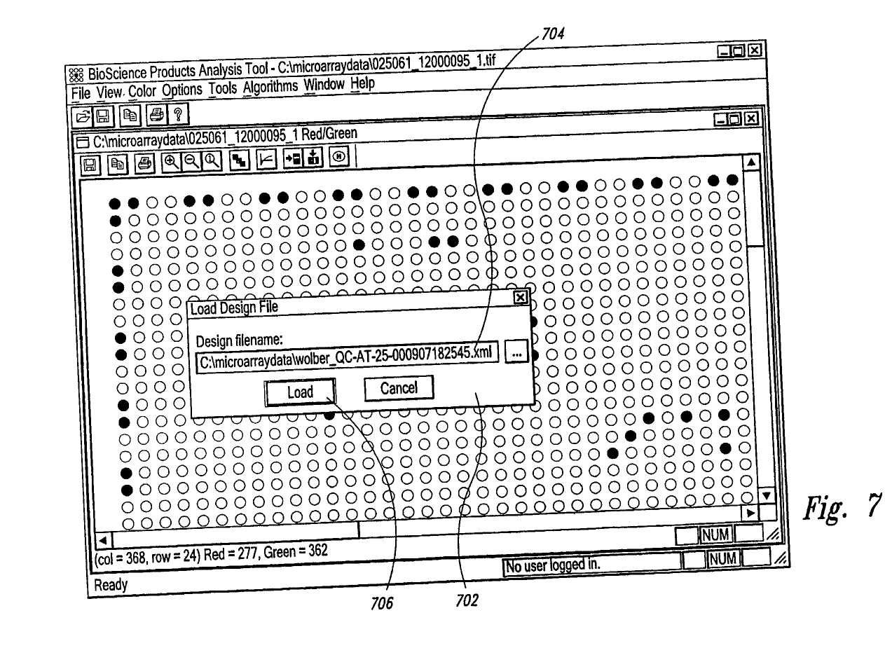

FIG. 6 shows the visual display of a molecular array feature extraction software package during invocation of feature extraction. In FIG. 6, a user has input a mouse click to an “Algorithms” button 602, which causes display of an “Algorithms” menu 604. By positioning the mouse cursor to select the option “Feature Extractor,” a user launches feature extraction from the displayed molecular array. As feature extraction begins, the molecular array feature extraction software package displays a “Load Design File” dialogue box. FIG. 7 shows display of the “Load Design File” dialogue box by a molecular array feature extraction software package. The “Load Design File” dialogue box 702 allows a user to input, or to override an automatically detected, name and directory path of an XML design file which contains characteristics and parameters describing the molecular array from which features are to be extracted. Once a valid design file is textually described in the text window 704 and the user inputs a mouse click to a load button 706, the molecular array feature extraction software package opens the design file and extracts from the design file information needed for feature extraction.

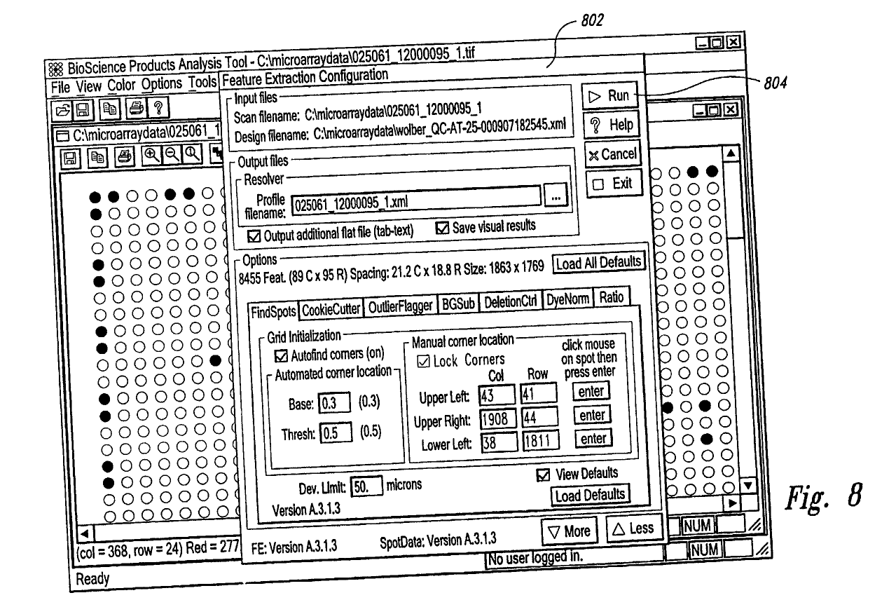

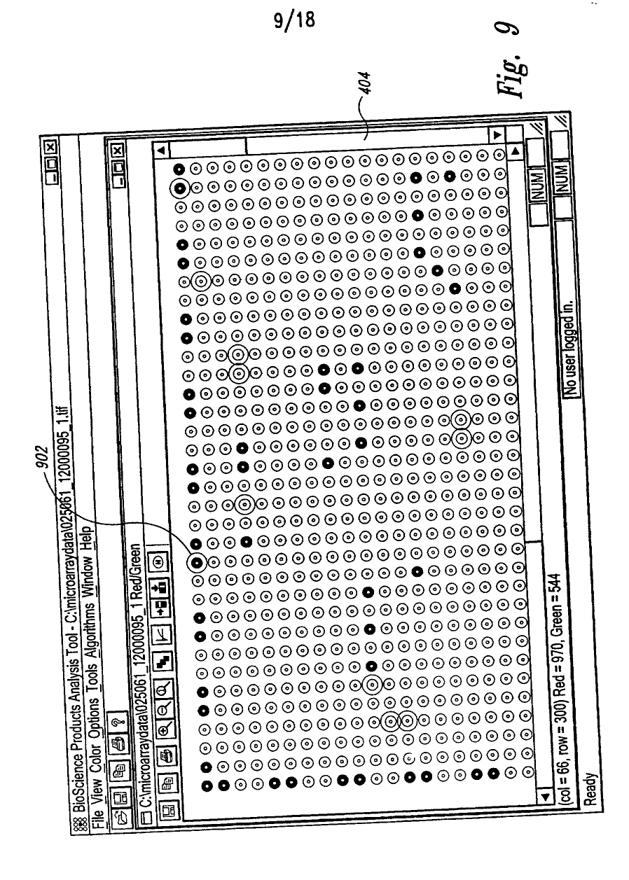

Next, the molecular array feature extraction software package displays to the user a “Feature Extraction Configuration” interactive parameter input window. FIG. 8 shows the visual display featuring the “Feature Extraction Configuration” interactive parameter input window. The interactive parameter input window 802 allows the user to configure feature extraction. A user may, for example, choose fully automated corner feature positions determination, or may manually input the positions of corner features in the case that corner features are obscured or distorted in the scanned image. The user may also choose different approaches to statistical analysis of feature data, thresholds and parameters for designating features as outliers, parameters that control the types and forms of output of results, and to input a variety of other information. Once the displayed input parameters are acceptable to the user, the user may input a mouse click to the “Run” button 804 to launch feature extraction. When feature extraction has completed, the molecular array feature extraction software package displays feature extraction results superimposed over the scanned image of the molecular array. FIG. 9 shows feature extraction results displayed superimposed over the scanned image of the molecular array. Comparison of FIG. 6 and FIG. 9 shows that the molecular array image display window 404 in FIG. 9 displays visual information in addition to the scanned image display, displayed in both FIGS. 6 and 9. For example, note the thin, light-colored ring 902 around the thirteenth feature in the first row of the molecular array displayed in FIG. 9.

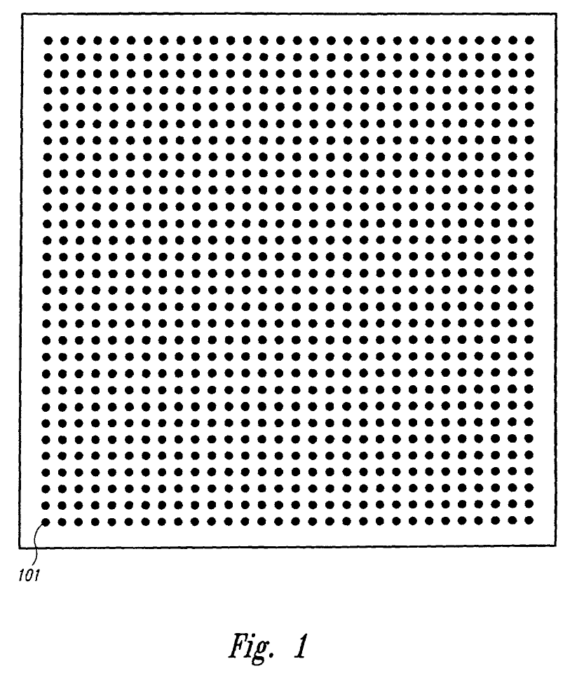

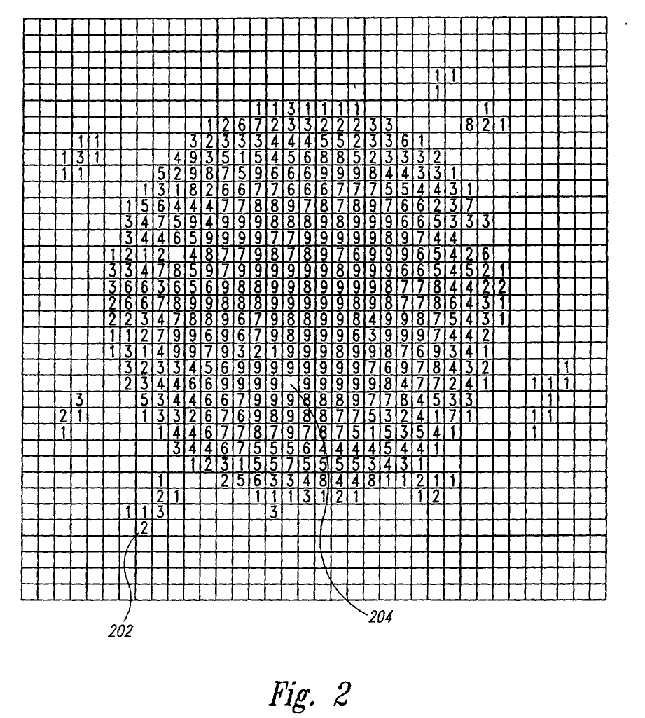

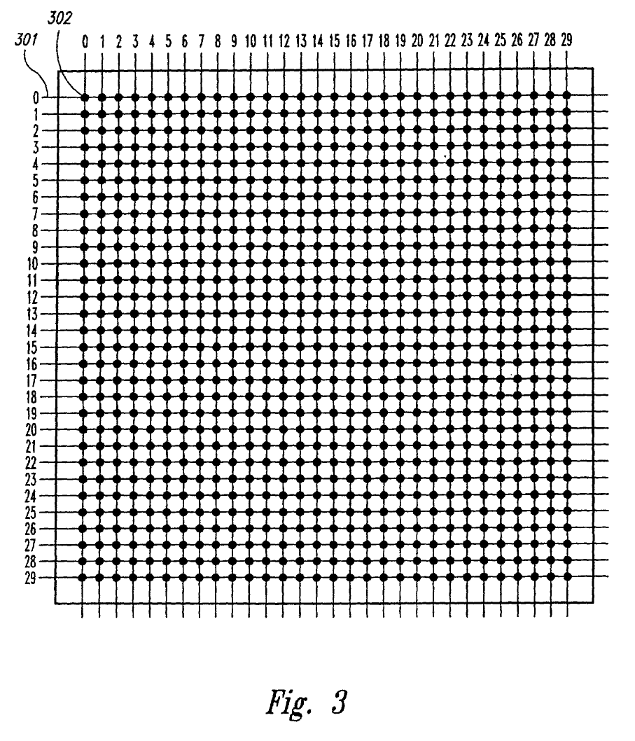

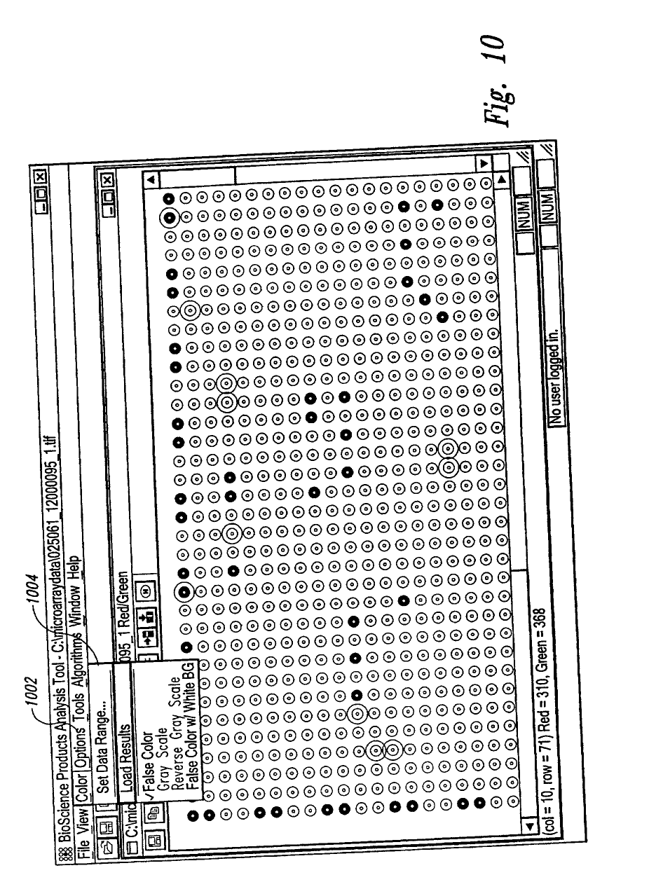

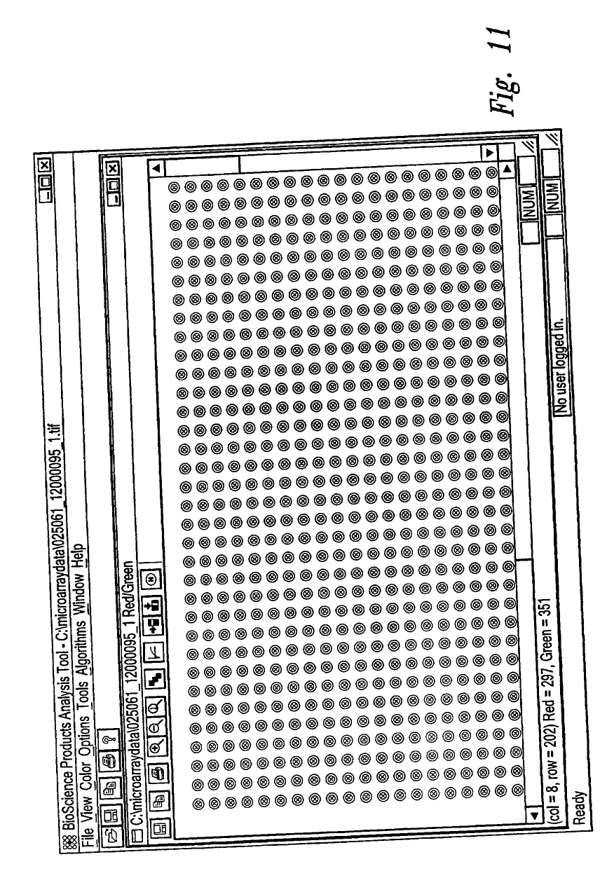

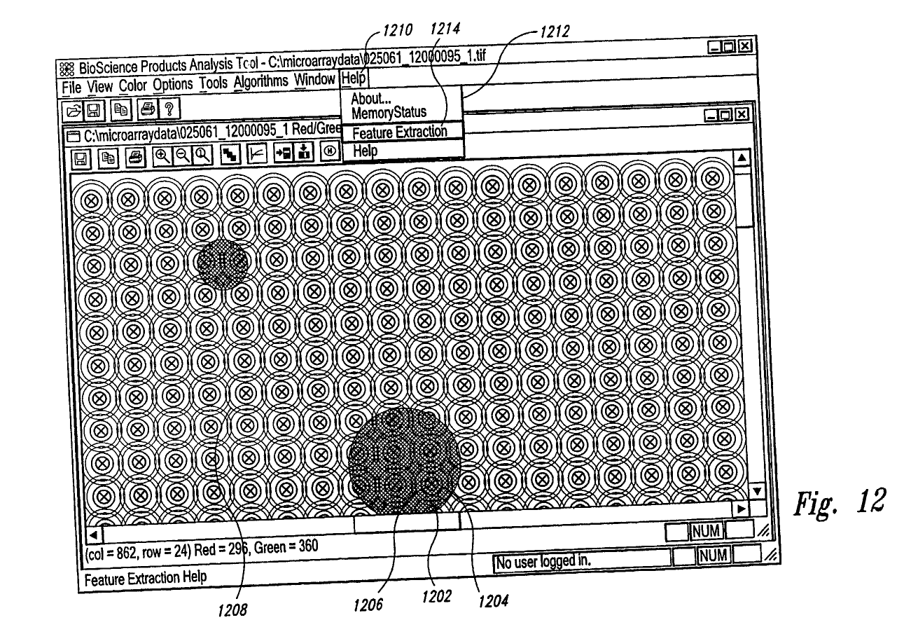

A user may alternatively display the scanned image of the molecular array, using a logarithmic color scale rather than the false color representation shown in FIGS. 1-10. FIG. 10 shows display of an “Options” menu that allows selection of the color scale for display of a scanned molecular array image. In FIG. 10, a user has input a mouse click to an “Options” button 1002 to invoke the “Options” menu 1004. By positioning the mouse cursor over the “User Log Color Scale” option, the user may select a logarithmic color scale. FIG. 11 shows display of the feature extraction result superimposed on the scanned image of the molecular array following selection, by the user, of a logarithmic color scale. FIG. 12 shows display of the feature extraction results superimposed on the scanned image of the molecular array in a logarithmic color scale at higher magnification. Note that, in FIG. 12, a number of visual display markings are superimposed over each feature. These visual display markings include two outer solid-color circles, for example outer circles 1202, an inner solid-color circle, for example inner circle 1204, a large solid-colored cross, such as solid-colored cross 1206, and, in some features, a smaller white cross, such as smaller white cross 1208. The smaller white cross 1208 is oriented with cross members parallel to the molecular array image display window edges, while the larger, solid-colored cross is displayed with cross members at 45 angles to the edges of the molecular image display window. The molecular array feature extraction software package, following input of a mouse click to a “Help” button 1210, displays a “Help” menu 1212 from which the user may select the “Feature Extraction” option 1214 in order to obtain a key for the different visual markings that represent the results of feature extraction.

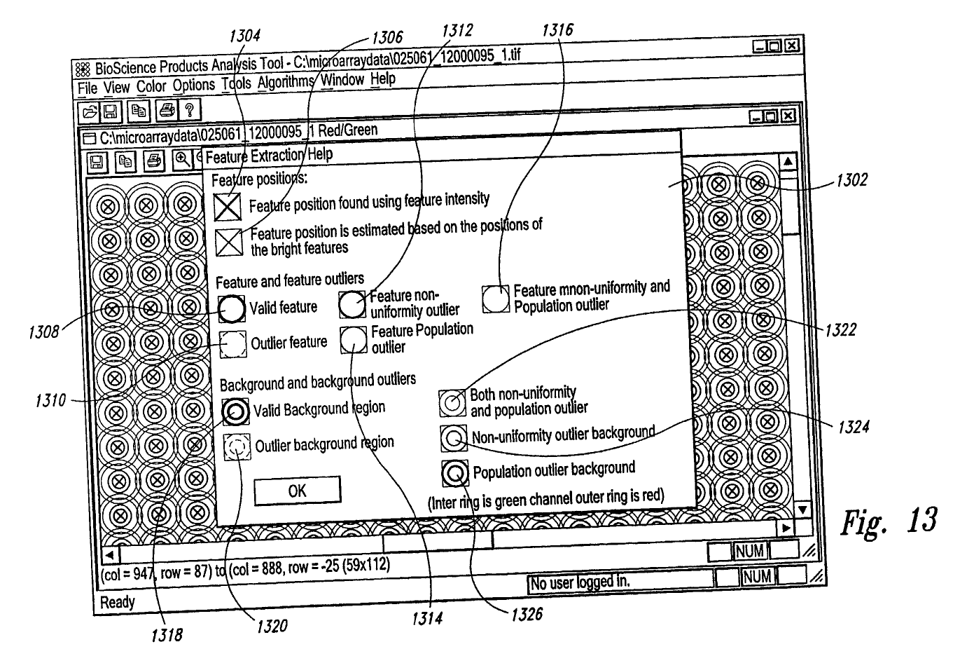

FIG. 13 shows the visual feature extraction result key displayed by the molecular array feature extraction software package. The visual feature extraction result key 1302 displays each different visual marking along with a text description of the marking. The visual display markings include: (1) a solid blue cross 1304 indicating the center of a feature found by analyzing pixel intensities within and near the feature; (2) a solid magenta cross 1306 indicating the center of a feature determined based on the feature's row and column indices and on a refined feature grid determined form the locations of strong features; (3) a solid blue, inner circle 1308 indicating a valid feature; (4) a solid yellow, inner circle 1310 representing an outlier feature; (5) a solid purple, inner circle 1312 representing an outlier feature characterized as being an outlier due to non-uniformity of pixel intensities within the feature; (6) a solid magenta, inner circle 1314 indicating an outlier feature classified as being an outlier due to statistical variance in signal intensity from other features; (7) a solid light-blue, inner circle 1316 indicating an outlier feature classified as being an outlier both because of non-uniformity of pixel intensities within the feature and because of statistical variance of the signal intensity of the feature with respect to that of other features of the array; (8) solid blue, double outer circles 1318 representing a valid background region around a feature; (9) solid yellow, double outer circles 1320 representing an outlier background region; (10) a solid light-blue-area, outer double circles 1322 indicating an outlier background region due both to non-uniformity of pixel intensity within the background as well as statistical variation of the signal intensity of the feature's background from that of other features in the array; (11) darker blue-area, double outer circles 1324 indicating a background outlier due to non-uniformity of pixel intensity within the background; and (12) darker blue-green, double outer circles 1326 indicating an outlier background around a feature due to variation of the signal intensity of the feature's background with respect to that of other features of the molecular array. For normal, strong features, the positions of which are found based on analysis of pixel intensity within the feature, as designated by the solid blue cross 1304, a small white cross is also superimposed over the feature at the feature's center calculated based on the refined coordinate grid. In the case of less-than-strong features, the white cross is not displayed, because the white cross, in such cases, always exactly overlie the magenta cross 1306.

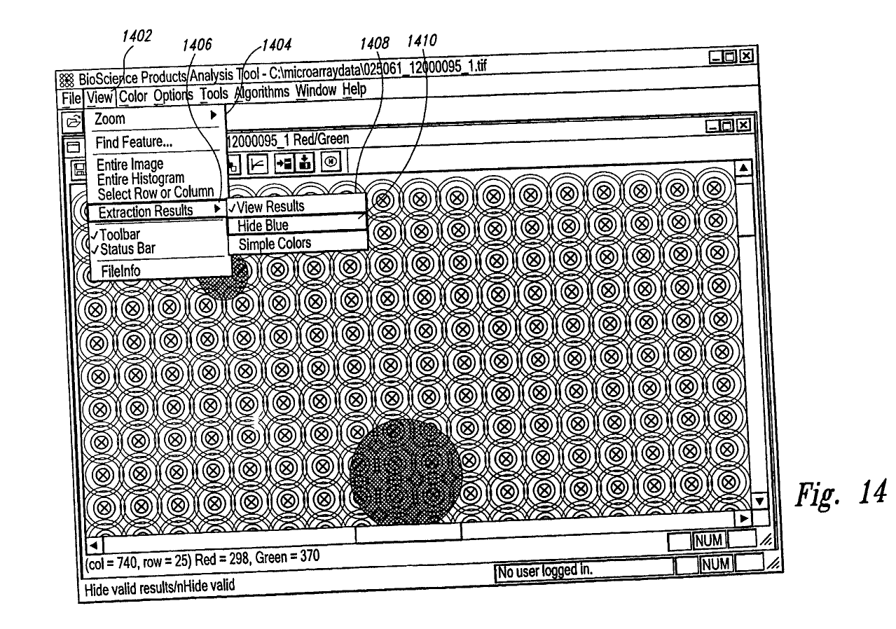

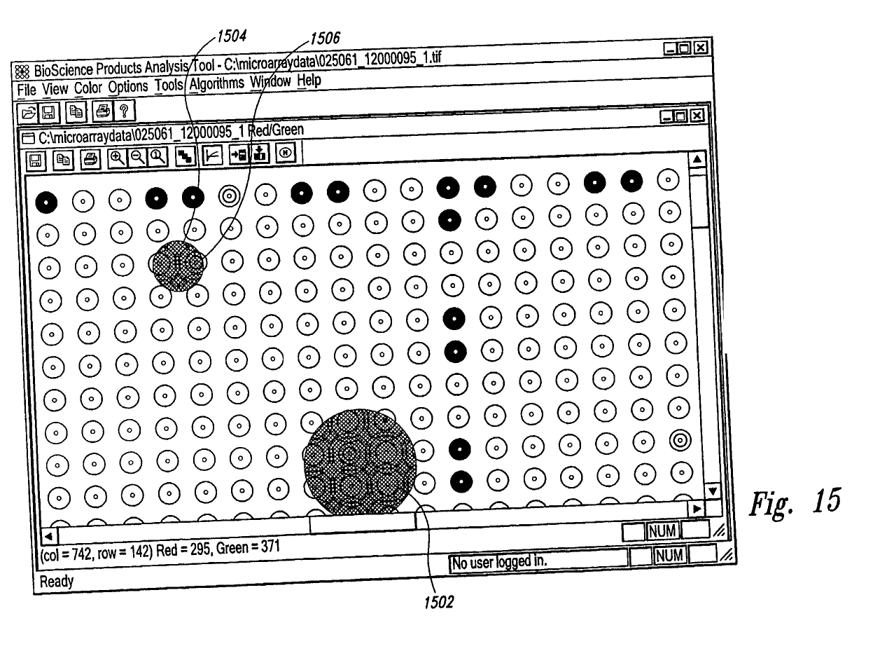

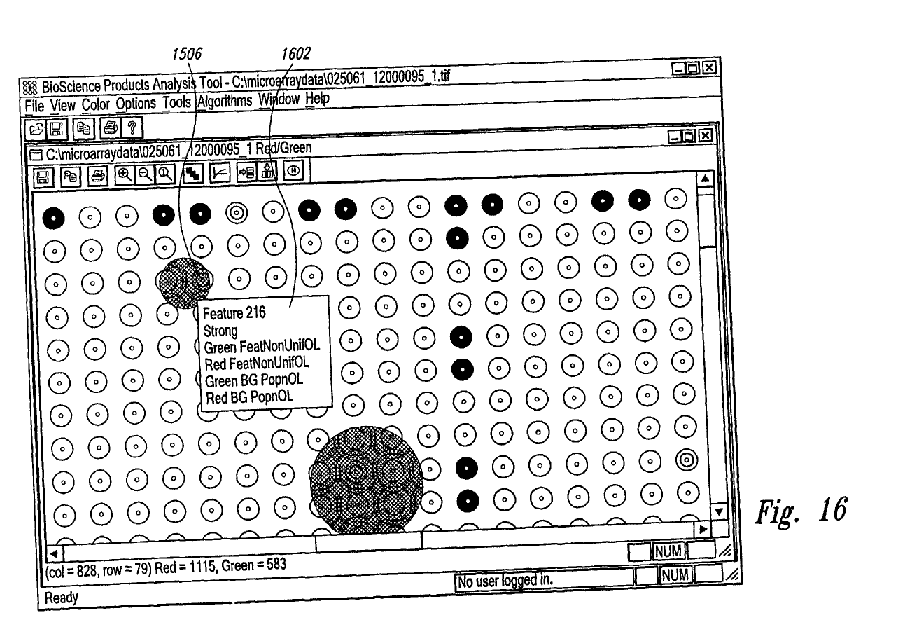

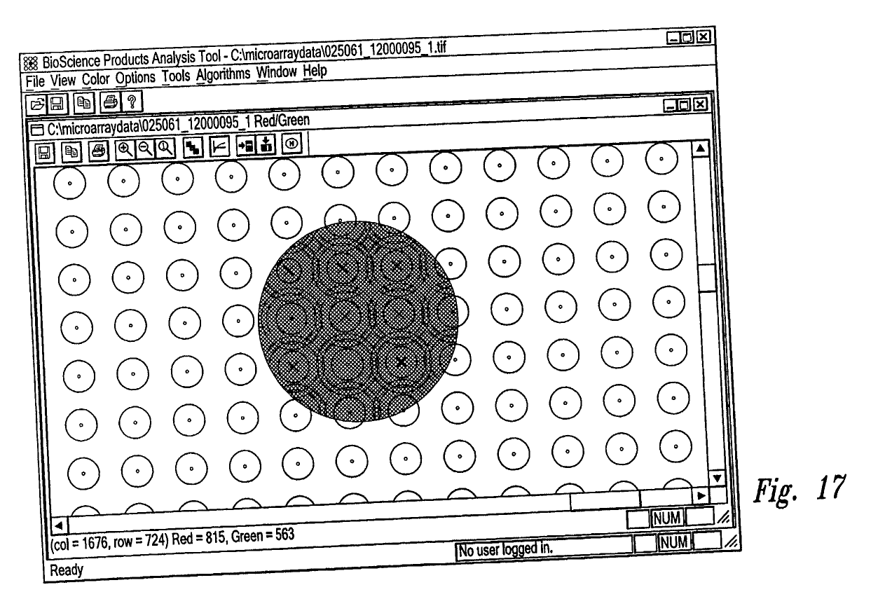

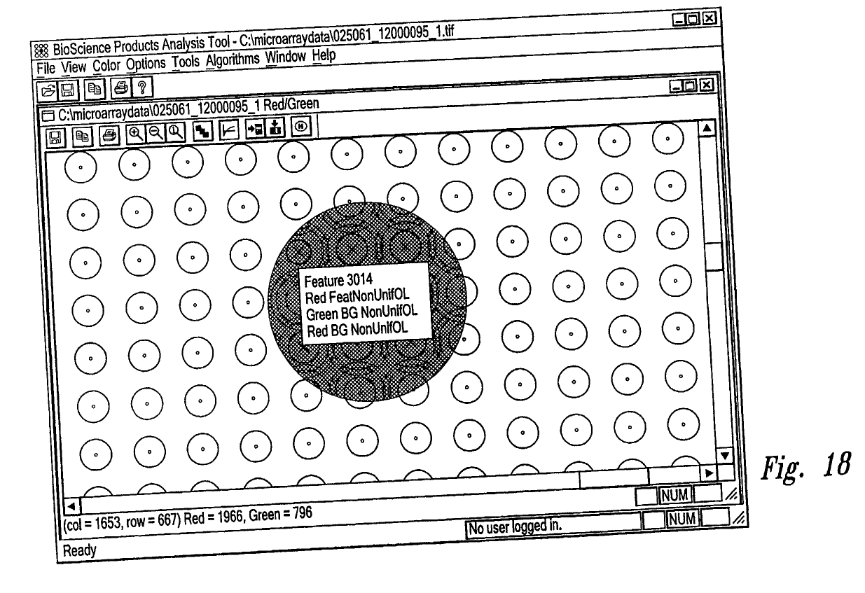

When all the visual display marks indicated in the visual display mark key 1302 are displayed, it may be difficult for a user to quickly spot outlier features or, in other words, features for which extracted data may be problematic. FIG. 14 shows user input to direct the molecular array feature extraction software package to display visual display markings for only those features characterized during feature extraction as outliers or having outlier backgrounds. The user inputs a mouse click to a “View” button 1402 resulting in display of a “View” menu 1404 from which the user selects the “Extraction Results” option 1406, in turn, invoking display of an “Extraction Results” menu 1408. By selecting the “Hide Blue” option 1410 from the “Extraction Results” menu 1408, the user directs the molecular array feature extraction software package to display visual display markings only for outlier features and backgrounds, or, in other words, for non-blue visual display markings. FIG. 15 shows display of feature extraction results for only outlier features or features having outlier backgrounds. Note, for example, the large circular smudge 1502 within the scanned image of the molecular array. Not surprisingly, features within the smudge area have been classified as features with outlier backgrounds. Note a second, smaller smudge 1504 with an outlier feature 1506. When a user wishes to see numerical and text-based feature extraction results for a particular features displayed in the molecular array image window, the user positions the mouse cursor over the feature of interest, and the molecular array feature extraction software package displays a text window, or tool kit, with selected feature extraction results. FIG. 16 shows a tool tip containing numerical and textual information regarding a feature. Such numerical and textual information may include numerical indications of background and feature signals, information about the target molecule for which the probe contained in the feature was designed, information about the probe molecule, and many other types of information. In FIG. 16, the users position the mouse cursor over outlier feature 1506, resulting in display of the text display window, or tool tip 1602. FIGS. 17 and 18 show display of the smudged area of the molecular array at higher magnification, with a tool tip displayed for a feature within the smudged region in FIG. 18.

Although the present invention has been described in terms of a particular embodiment, it is not intended that the invention be limited to this embodiment. Modifications within the spirit of the invention will be apparent to those skilled in the art. For example, many different types, colors, and sizes of visual feature extraction result markings may be displayed, with corresponding annotation in one or more visual display mark keys. Different numbers of display windows, feature options, and other GUI devices may be employed to implement the present invention. Alternative methods for displaying the scanned image of the molecular array may be employed, different information may be included within tool tips, and additional visual rendering of additional feature extraction information may be employed. For example, textual information concerning the chemical and/or biological identity of probe molecules contained within features, or the identities of the probe molecules' intended targets, may be additionally displayed to users.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A graphical user interface that displays results of a feature extraction process carried out on data collected from a molecular array, the graphical user interface comprising:
a molecular array image display component that displays an image of the molecular array; and
a feature-extraction-results rendering component that displays feature extraction results concurrently with, and correlated with, display of the molecular array image, the feature extraction results including results of statistical analysis, by the feature extraction process, of data collected from the molecular array and including one or more metrics that indicate quality of the signals extracted from the features of the molecular array.

2. The graphical user interface of claim 1 wherein the feature extraction results include positions of features of the molecular array within the image of the molecular array.

3. The graphical user interface of claim 1 wherein the feature extraction results include results of statistical analysis of signals extracted from background regions surrounding features.

4. The graphical user interface of claim 1 wherein the feature extraction results include one or more metrics that indicate quality of the signals extracted from background regions surrounding features of the molecular array.

5. The graphical user interface of claim 1 wherein the feature extraction results include numerical, textual, or numerical and textual information specific to each feature, including extracted signal intensities and positions within a coordinate system determined for the molecular array.

6. The graphical user interface of claim 1 wherein the graphical user interface optionally displays feature extraction results only for outlier features and feature backgrounds.

7. The graphical user interface of claim 1 wherein the graphical user interface displays numerical, textual, or numerical and textual information specific to a feature in a tool tip in response to input identifying a particular feature.

8. The graphical user interface of claim 7 wherein the input constitutes positioning of a cursor over the feature in the displayed image of the molecular array.

9. The graphical user interface of claim 1 wherein results of the feature extraction process are displayed as graphical objects superimposed on the displayed image of the molecular array.

10. The graphical user interface of claim 9 wherein the displayed graphical objects include:
a first type of indication indicating a statistically valid feature;
a second type of indication indicating a statistically invalid feature;
a third type of indication indicating a statistically valid feature background;
a fourth type of indication indicating a statistically invalid feature background; and
a fifth type of indication indicating the position of a feature in the displayed image of the molecular array.

11. The graphical user interface of claim 10 wherein the first, second, third, and fourth types of indications are planar figures selected from among closed planar figures that include:
circles;
squares;
polygons;
ellipses;
rectangles; and
irregular shaped closed figures.

12. The graphical user interface of claim 10 wherein the fifth type of indication is a positioning figure selected from among positioning figures including:
crosses;
points; and
arrows.

13. The graphical user interface of claim 10 wherein the first and third types of indications that indicate a statistically valid feature and a statistically valid feature background, respectively, have a common color distinct from the colors of the second, fourth, and fifth types of features.

14. The graphical user interface of claim 10 wherein the second and fourth types of indications that indicate a statistically invalid feature and a statistically invalid feature background, respectively, have a common color distinct from the colors of the first, second, and fifth types of features.

15. A method for visually displaying results of a feature extraction process carried out on data collected from a molecular array, the method comprising:
displaying an image of a molecular array; and
superimposing graphical objects over positions of features on the displayed image of the molecular array, a displayed graphical object representing a result of the feature extraction process for the feature over which the displayed graphical object is superimposed on the displayed image of the molecular array.

16. The method of claim 15 further including:
upon receiving an input indication of a feature, displaying a tool tip including an alphanumeric representation of information related to the feature, including results from the feature extraction process.

17. The method of claim 16 wherein the input indication is positioning of a graphical pointer over the position of the feature in the displayed image of the molecular array.

18. The method of claim 15 further including:
upon receiving an option selection indication, displaying graphical objects superimposed only over statistical outlier features and feature backgrounds.

19. The method of claim 15 wherein displayed graphical objects include:
a first type of indication indicating a statistically valid feature;
a second type of indication indicating a statistically invalid feature;
a third type of indication indicating a statistically valid feature background;
a fourth type of indication indicating a statistically invalid feature background; and
a fifth type of indication indicating the position of a feature in the displayed image of the molecular array.

20. The method of claim 19 wherein the first, second, third, and fourth types of indications are planar figures selected from among closed planar figures that include:
circles;
squares;
polygons;
ellipses;
rectangles; and
irregular shaped closed figures.

21. The method of claim 19 wherein the fifth type of indication is a positioning figure selected from among positioning figures including:
crosses;
points; and
arrows.

22. The method of claim 19 wherein the first and third types of indications that indicate a statistically valid feature and a statistically valid feature background, respectively, have a common color distinct from the colors of the second, fourth, and fifth types of features.

23. The method of claim 19 wherein the second and fourth types of indications that indicate a statistically invalid feature and a statistically invalid feature background, respectively, have a common color distinct from the colors of the first, second, and fifth types of features.

24. A method comprising reading a sample exposed array, visually displaying results using a method according to claim 15, and further processing the results from reading based on the visually displayed results.

25. A method comprising forwarding data representing a result obtained by the method of claim 24.

26. A method according to claim 25 wherein the data is communicated to a remote location.
